(19) United States
(12) Patent Application Publication
(10) Pub. No.: US 2009/0138459 A1
(43) Pub. Date: May 28, 2009

(54) System and Method of Searching for Video Content

(75) Inventors: Edward Walter, Boerne, TX (US); Michael Raftelis, San Antonio, TX (US)

Correspondence Address: AT&T Legal Department - LNAP;Attn: Patent Docketing, Room 2A- 207, One AT & T Way, Bedminster, NJ, 07921, US

(73) Assignee: AT&T KNOWLEDGE VENTURES, LP, Reno, NV (US)

(21) Appl. No.: 11/945,375

(22) Filed: Nov. 27, 2007

(51) Int. Cl. G06F 17/30; G06F 3/048

(52) U.S. Cl. 707/5; 715/764; 707/E17.032; 707/E17.109

(57) ABSTRACT

A method of searching video content includes searching the video content according to criteria defined by a user, and sending a notice to an electronic calendar with at least one entry that meets the criteria. A graphical user interface performing the method is also disclosed.

### FIELD OF THE DISCLOSURE

The present disclosure relates generally to media services, and relates more specifically to a system and method for universal video content search.

### BACKGROUND

The amount of multimedia content available through subscription television services and video on demand is large and growing. As a result, it is increasingly difficult for subscribers to locate the content they desire. In deployed networks with digital set-top boxes, satellite receivers or personal video recorders, the conventional methods of accessing multimedia content include manipulating an onscreen graphical user interface using a handheld infrared or radio frequency remote control device. To find content in such an environment, a user navigates hierarchical menus or has to spell out titles or other search terms using an onscreen keyboard or in some cases using triple tap input on the remote control.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of selected elements of a multimedia content distribution network;

FIG. 2 is an exemplary screen shot of a preferences tab of a network content search graphical user interface;

FIG. 3 is an exemplary screen shot of a general tab of a network content search graphical user interface;

FIG. 4 is an exemplary screen shot of a notification and print tab of a network content search graphical user interface;

FIG. 5 is an exemplary screen shot of a search criteria tab of a network content search graphical user interface

FIG. 6 is an exemplary screen shot of a customization tab of a network content search graphical user interface; and

FIG. 7 is an exemplary screen shot of a security tab of a network content search graphical user interface.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

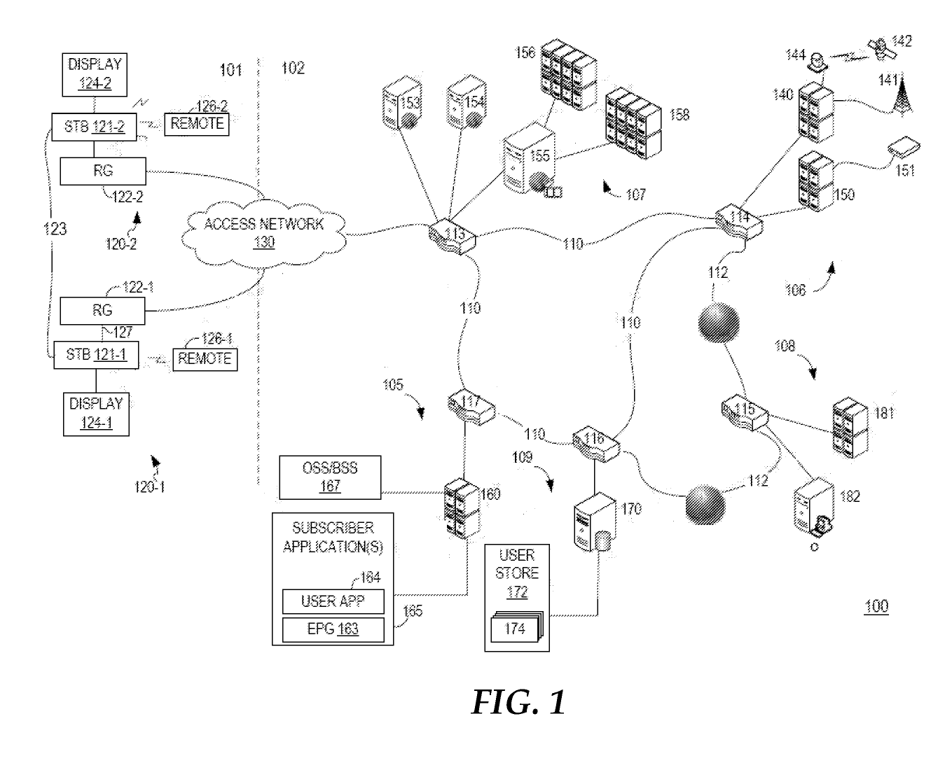

FIG. 1 illustrates selected aspects of an embodiment of a multimedia content distribution network (MCDN) 100. MCDN 100 as shown may be generally divided into a client side 101 and a service provider or server side 102. The client side 101 includes all or most of the resources depicted to the left of access network 130 while the server side encompasses the remainder. Client side 101 and server side 102 are linked by access network 130. In embodiments of MCDN 100 that leverage telephony hardware and infrastructure, access network 130 may include the “local loop” or “last mile,” which refers to the physical wires that connect a subscriber's home or business to a local exchange. In these embodiments, the physical layer of access network 130 may include twisted pair copper cables or fiber optics cables employed either as fiber to the curb (FTTC) or fiber to the home (FTTH). It should also be understood that the access network may include wireless technologies such as fixed wireless, WiMax, or cellular protocols such as EVDO or HSPDA.

Access network 130 may include hardware and firmware to perform signal translation when the access network has multiple types of physical media. For example, an access network that includes twisted-pair telephone lines to deliver multimedia content to consumers may utilize digital subscriber line (DSL) technology. In embodiments of access network 130 that implement FTTC, a DSL access multiplexer (DSLAM) may be used within the access network to transfer signals containing multimedia content from optical fiber to copper wire for DSL delivery to consumers. In other embodiments, access network 130 may transmit radio frequency (RF) signals over coaxial cables. In these embodiments, access network 130 may utilize quadrature amplitude modulation (QAM) equipment for downstream traffic. In these embodiments, access network 130 may receive upstream traffic from a consumer's location using quadrature phase shift keying (QPSK) modulated RF signals. In such embodiments, a cable modem termination system (CMTS) may be used to mediate between IP-based traffic on a private network 110 and access network 130.

Services provided by the server side resources as shown in FIG. 1 may be distributed over the private network 110. In some embodiments, private network 110 is referred to as a “core network.” In at least some of these embodiments, private network 110 includes a fiber optic wide area network (WAN), referred to herein as the fiber backbone, and one or more video hub offices (VHOs). In large scale implementations of MCDN 100, which may cover a geographic region comparable, for example, to the region served by telephony-based broadband services, private network 110 includes a hierarchy of VHOs.

A central or national VHO, for example, may deliver national content feeds to several regional VHOs, each of which may include its own acquisition resources to acquire local content, such as the local affiliate of a national network, and to inject local content such as advertising and public service announcements from local entities. The regional VHOs may then deliver the local and national content for reception by subscribers served by the regional VHO. The hierarchical arrangement of VHOs, in addition to facilitating localized or regionalized content provisioning, may conserve scarce and valuable bandwidth by limiting the content that is transmitted over the core network and injecting regional content “downstream” from the core network.

Segments of private network 110 as shown in FIG. 1 are connected together with a plurality of network switching and routing devices referred to simply as switches 113 through 117. The depicted switches include client facing switch 113, acquisition switch 114, operations-systems-support/business-systems-support (OSS/BSS) switch 115, database switch 116, and an applications switch 117. In addition to providing routing/switching functionality, switches 113 through 117 preferably include hardware or firmware firewalls, not depicted, that maintain the security and privacy of network 110. Other portions of MCDN 100 communicate over a public network 112, including, for example, the Internet or other type of web-network where the public network 112 is signified in FIG. 1 by the World Wide Web icon.

The client side 101 of MCDN 100 depicts two of a potentially large number of client side resources referred to herein simply as client(s) 120. Each client 120 as shown includes a set-top box (STB) 121, a residential gateway (RG) 122, a display 124, and a remote control device 126. In the depicted embodiment, STB 121 communicates with server side devices through access network 130 via RG 122. RG 122 may include elements of a broadband modem such as a DSL modem, as well as elements of a router and/or access point for an Ethernet or other suitable local area network (LAN) 127. In this embodiment, STB 121 is a uniquely addressable Ethernet compliant device. In some embodiments, display 124 may be any NTSC and/or PAL compliant display device. Both STB 121 and display 124 may, but do not necessarily include any form of conventional frequency tuner. Remote control device 126 communicates wirelessly with STB 121 using an infrared (IR) or RF signal. IR-based remote control devices are economical but limited to line of sight operation whereas RF-based remote control devices are omni-directional, but more expensive to implement and more demanding in terms of power consumption.

In Internet Protocol Television (IPTV) compliant implementations of MCDN 100, the clients 120 are operable to receive packet-based multimedia streams from access network 130 and process the streams for presentation on display 124. In addition, clients 120 are network-aware systems that may facilitate bidirectional networked communications with server side 102 resources to facilitate network hosted services and features. Because clients 120 are operable to process multimedia content streams while simultaneously supporting more traditional web-like communications, clients 120 may support or comply with a variety of different types of network protocols including streaming protocols such as RDP (reliable datagram protocol) over UDP/IP (user datagram protocol/internet protocol) as well as more conventional web protocols such as HTTP (hypertext transport protocol) over TCP/IP (transport control protocol).

The server side 102 of MCDN 100 as depicted in FIG. 1 emphasizes network capabilities including application resources 105, which may or may not have access to database resources 109, content acquisition resources 106, content delivery resources 107, and OSS/BSS resources 108. Before distributing multimedia content to subscribers, MCDN 100 must first obtain multimedia content from content providers. To that end, acquisition resources 106 encompass various systems and devices to acquire multimedia content, reformat it when necessary, and process it for delivery to subscribers over private network 110 and access network 130.

Acquisition resources 106 may include, for example, systems for capturing analog and/or digital content feeds, either directly from a content provider or from a content aggregation facility. Content feeds transmitted via VHF/UHF broadcast signals may be captured by an antenna 141 and delivered to live acquisition server 140. Similarly, live acquisition server 140 may capture down linked signals transmitted by a satellite 142 and received by a parabolic dish 144. In addition, live acquisition server 140 may acquire programming feeds transmitted via high-speed fiber feeds or other suitable transmission means. Acquisition resources 106 may further include signal conditioning systems and content preparation systems for encoding content.

Content acquisition resources 106 include a video on demand (VoD) acquisition server 150. VoD acquisition server 150 receives content from one or more VoD sources that may be external to the MCDN 100 including, as examples, discs represented by a DVD player 151, or transmitted feeds (not shown). VoD acquisition server 150 may temporarily store multimedia content for transmission to a VoD delivery server 158 in communication with client-facing switch 113. After acquiring multimedia content, acquisition resources 106 may transmit acquired content over private network 110, for example, to one or more servers in content delivery resources 107. Prior to transmission, live acquisition server 140 may encode acquired content using, e.g., MPEG-2, H.263, a WMV (Windows Media Video) family codec, or another suitable video codec. Encoding acquired content is desirable to compress the acquired content to preserve network bandwidth and network storage resources and, optionally, to provide encryption for securing the content. VoD content acquired by VoD acquisition server 150 may be in a compressed format prior to acquisition and further compression or formatting prior to transmission may be unnecessary and/or optional.

Content delivery resources 107 as shown in FIG. 1 are in communication with private network 110 via client facing switch 113. In the depicted implementation, content delivery resources 107 include a content delivery server 155 in communication with a live or real-time content server 156 and a VoD delivery server 158. For purposes of this disclosure, the use of the term “live” or “real-time” in connection with content server 156 and multimedia content generally is intended primarily to distinguish the applicable content from the content provided by VoD delivery server 158. The content provided by a VoD server is sometimes referred to as time-shifted content to emphasize the ability to obtain and view VoD content substantially without regard to the time of day or day of week. Live content, in contrast, is only available for viewing during its scheduled time slot unless the content is recorded with a DVR or similar device.

Content delivery server 155, in conjunction with live content server 156 and VoD delivery server 158, responds to subscriber requests for content by providing the requested content to the subscriber. The content delivery resources 107 are, in some embodiments, responsible for creating video streams that are suitable for transmission over private network 110 and/or access network 130. In some embodiments, creating video streams from the stored content generally includes generating data packets by encapsulating relatively small segments of the stored content in one or more packet headers according to the network communication protocol stack in use. These data packets are then transmitted across a network to a receiver, e.g., STB 121 of client 120, where the content is parsed from individual packets and re-assembled into multimedia content suitable for processing by a set top box decoder.

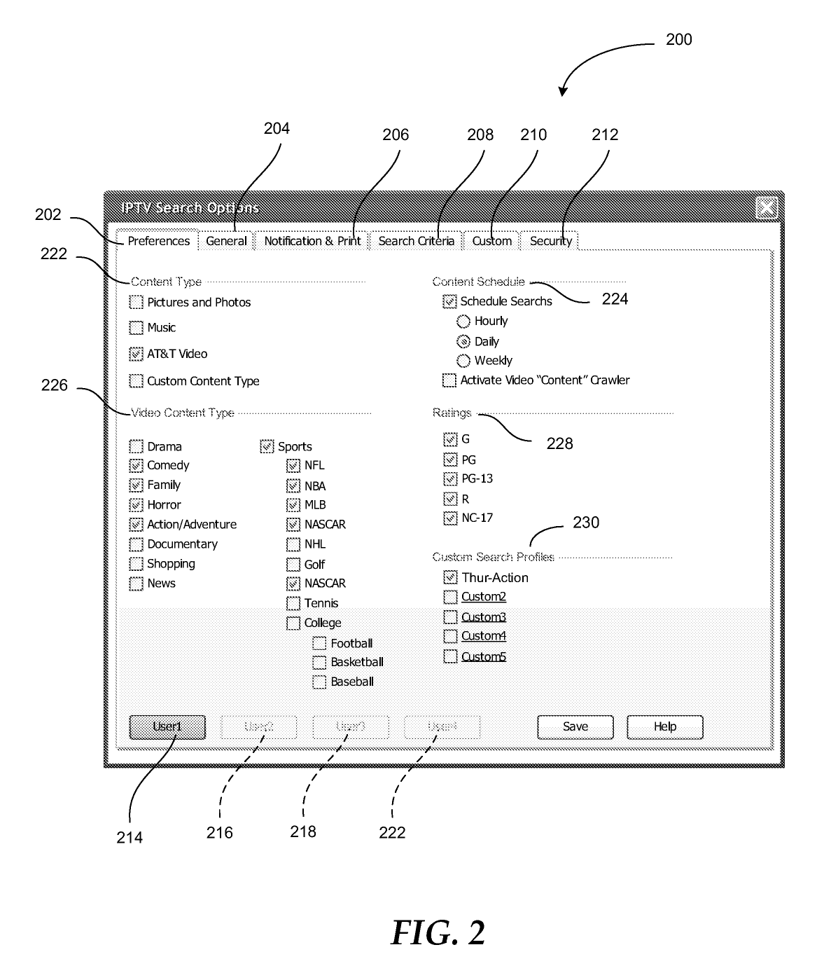

FIG. 2 shows an exemplary embodiment of a graphical user interface (GUI) 200 that may be shown on the display 124. The GUI 200 may be configured to access a media receiver such as the STB 121, and services managed thereby such as a digital video recorder (DVR), an electronic programming guide (EPG), a VoD catalog, and a personal catalog stored in the STB having items such as personal videos, pictures, and audio recordings. The GUI 200 may be used to designate content search criteria, and includes separate pages that may be selected by tabs 202, 204, 206, 208, 210 and 212. The GUI for tab 202, which relates generally to user preferences, accommodates multiple users as indicated by selectable buttons 214, 216, 218 and 220. For any given button, the user may select default options related generally to categories such as content type 222, content schedule 224, video content type 226, ratings 228, and custom search profiles 230.

Within the content type category 222, the user may designate one or more of pictures and photos, music, service provider video, custom content type or the like. Within the content schedule category 224, the user may choose to schedule searches hourly, daily, or weekly, or to activate a video content crawler. Within the video content type category 226, the user may designate one or more of drama, comedy, family, horror, action/adventure, documentary, shopping, news, sports (further definable as shown), or the like. With the rating category 228, the user may designate content assigned a rating of G, PG, PG-13, R, NC-17 for movies or a similar rating assigned for other content such as games or music. With the custom search profiles category 230, the user may designate various customized search profiles created as described more fully below. When the user is selecting search from the STB, these options can also be modified by going to an advance button and changing them. Also, the user can change the options by hitting a pre-defined “selection” key that will automatically add or delete a currently viewed content category from the default configuration. For example, a user is watching a drama may decide to add it to his or her default search configuration by selecting a pre-defined key on the remote control which signals the STB to update the User1 search profile with “drama” enabled.

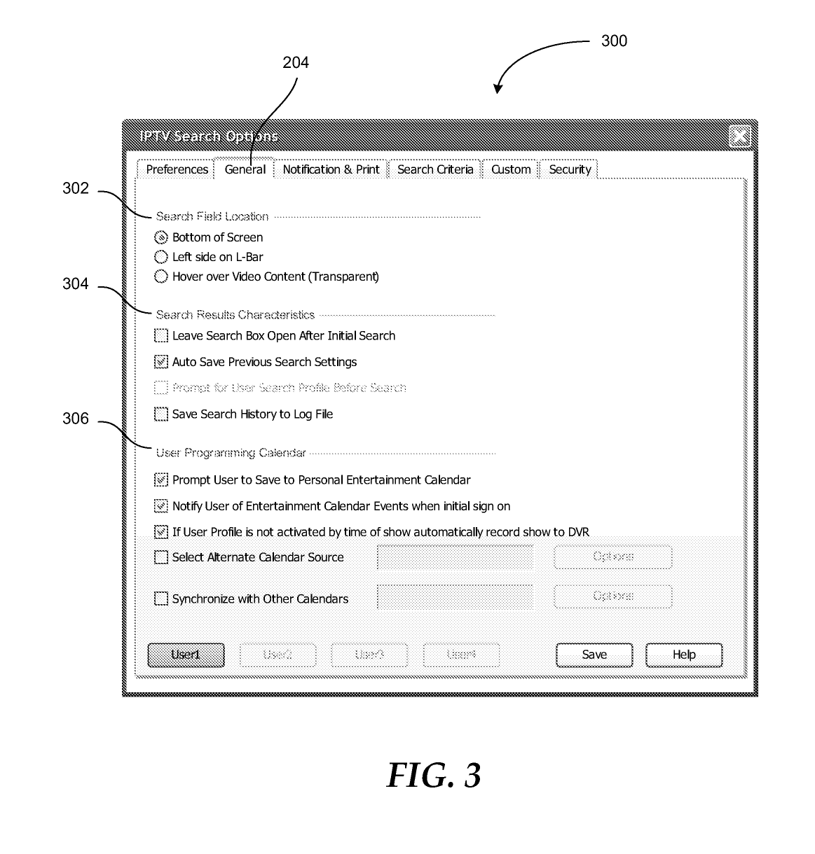

FIG. 3 shows an exemplary GUI 300 for the general tab 204, which includes categories for search field location 302, search results characteristics 304, and user programming calendar 306. Within the search field location category 302, the user may choose to display the search field at the bottom of the screen, at the left side of an L-bar, or to hover transparently over whatever is then being shown on the display. Within the search results characteristic category 304, the user may choose to leave the search box open after an initial search, to automatically save previous search settings, to prompt for user search profile before searching, or to save the search history to a log file. Within the user programming calendar category 306, the user may choose to have the system prompt him or her to save the start and/or end time of any located content to a personal entertainment calendar, notify him or her of entertainment calendar events when they sign on, automatically record a show to the DVR if the user's profile is not activated by the time of the show, select an alternate calendar source, and/or synchronize with other calendars.

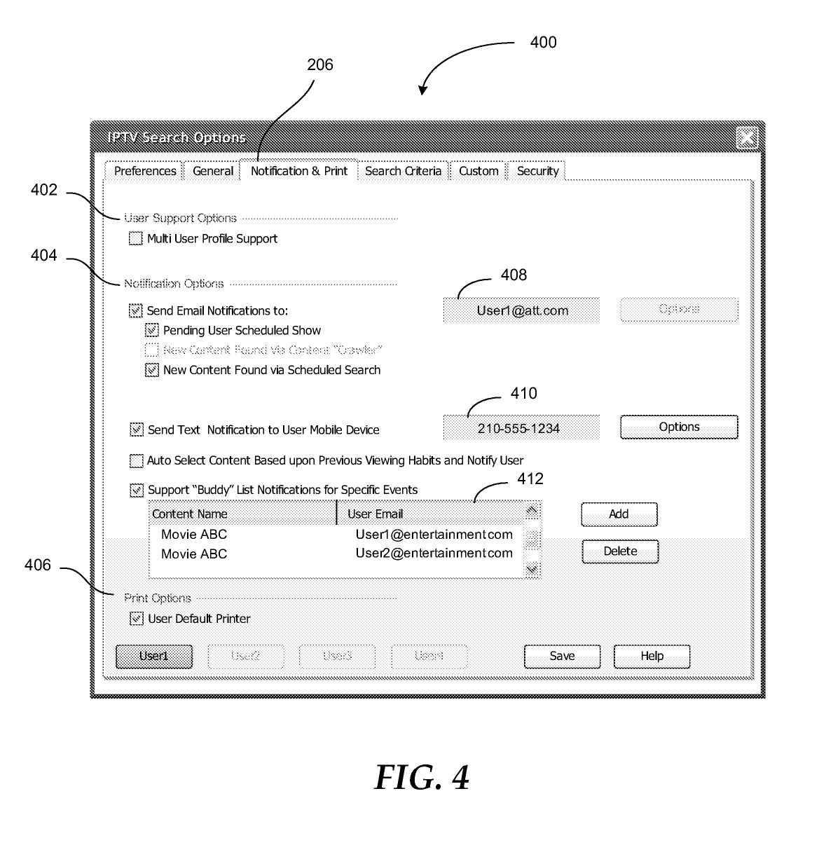

FIG. 4 shows an exemplary GUI 400 for the notification and print tab 206, which includes categories for user support options 402, notification options 404, and print options 406. Within the user support options category 402, the user may choose multiple user profile support. By selecting User1, User2, User3, or User4 a customized profile can be created for selection by different users within a household. These user profiles may be assigned for selection from a button on a remote or via GUI access within the Electronic Programming Guide. Within the notifications options category 404, the user may choose to send email notifications (to pending user scheduled shows, new content found through the content crawler, and/or new content located via the scheduled search) to an address definable in field 408, or to send text notifications to an address definable in field 410. The user may also choose to automatically select content based on previous viewing habits (and then notify the user), and/or to support buddy list notification of friends or family for specific events that the user may define in field 412. Within the print options category 406, the user may set a default printer to which any output generated by the system may be sent.

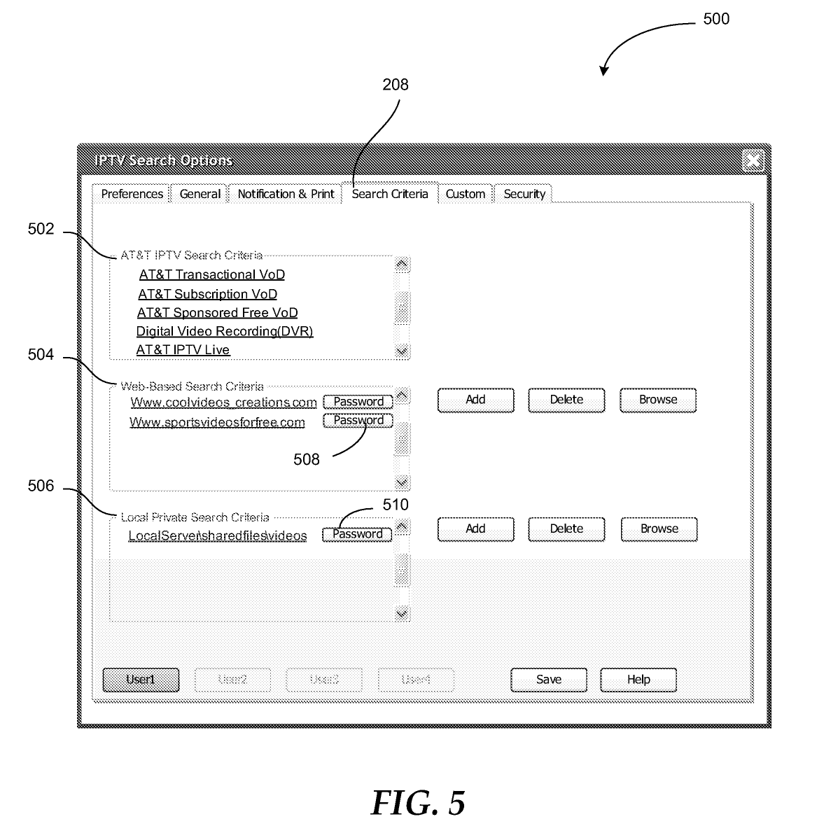

FIG. 5 shows an exemplary GUI 500 for the search criteria tab 208, which includes categories for IPTV service provider search criteria 502, Internet-based search criteria 504, and local private search criteria 506. In a preferred embodiment, the entries within the IPTV service provider search criteria 502 are definable by the IPTV service provider, and may include things such as transactional VoD, subscription VoD, sponsored free VoD, DVR content, and live television content. Within the web-based search criteria 504, the user may enter hyperlinks to Internet URLs pointing to web pages with searchable content. Within the local private search criteria 506, the user may enter links to locally-stored searchable content. Password configuration buttons 508 and 510 may be provided for the user to automate any authentication that might be required for access to the web-based or locally-based content, respectively.

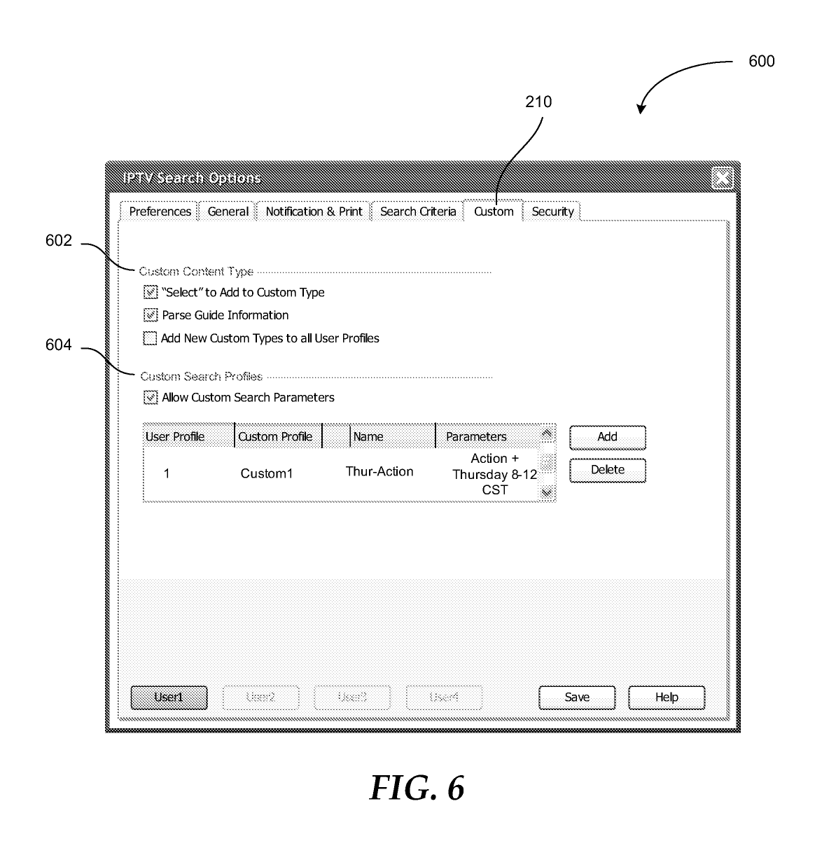

FIG. 6 shows an exemplary GUI 600 for the custom tab 210, which includes categories for custom content type options 602 and custom search profile options 604. Within the custom content type category 602, the user may choose one or more of select to add custom type, parse guide information, and add new custom types to all user profiles. Within the custom search profiles category 604, the user may choose to allow custom search parameters. When this option is selected, the user is presented with the ability to create custom Search Profiles based upon unique data. Thus, in the example depicted the user has created a custom profile named “Thur-Action” consisting of a search for Action content shown on Thursdays between the hours of 8-12 Central Standard Time.

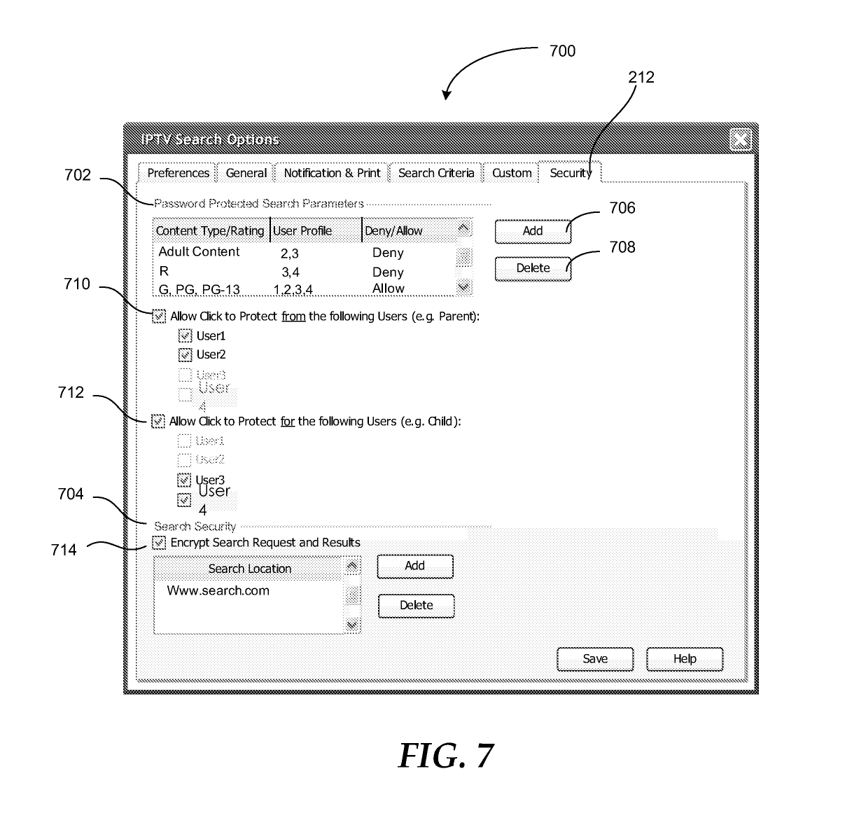

FIG. 7 shows an exemplary GUI 700 for the security tab 212, which includes categories for password protected search parameter options 702 and search security options 704. Within the password protected search parameter options 702, the user may set passwords to prevent minors or other users from searching for content that can be designated by rating for different combinations of users, and also to add or delete entries with respective buttons 706 and 708. Although not shown, the system may optionally provide the user with the same choices according to specific channels or programs. The user may also elect to allow click to protect from certain users by checking box 710, and/or to allow click to protect for certain users by checking box 712, and then designating the particular users in either instance. For example, a parent may elect to control the viewing and searching actions of a child. As a form of parental control a parent (User1 or User2) may narrow the abilities of a child (User3 or User4) to select specific actions placed upon a selected profile. In one embodiment, the parent may set hard restrictions that the child cannot change. In another embodiment, limits may be established within which the child may make changes to a specific set of parameters. Within the search security category 704, the user may by checking box 714 encrypt the search request and results exchanged with the STB and the Internet-based search engine. In a preferred embodiment, the IPTV search engine is defined by the service provider.

This disclosure thus provides a method and solution of integrating the search capabilities surrounding IPTV (or any other video content provider) with the ability to search all IPTV databases, Web based directories, local directory headers, special markings, and closed captioning information to allow profiling or classification of relevant video content. Additional functionality includes the ability to record the content time to a personal calendar, to notify the user when the show time is approaching via email or SMS-text message, to set up customized search profiles and map to a one-click search procedure, and to take customized search criteria and apply reoccurring search times.

An added value is the ability to automatically via email, SMS, MMS, or other protocols update a selected user calendar. Thus, the system may generate a “meeting-maker” with time and show information that is emailed to an identified user. This user may then accept the meeting, which populates the calendaring software on their personal or mobile computer. Additionally, the “meeting maker” allows the user to set a “live” or “record” option in case the user is busy during the time that the show is playing. The user may select an option within the “meeting maker” to record the show on their local DVR or optional recording device. This integrates the calendar with specific IPTV/STB/Video Content options and enhances the user experience.

This tool allows for all searchable Video Content information to be searched regardless of content provider, delivery mechanism, or physical/logical location. In addition, this solution integrates the user's Entertainment Calendar. Users can select content and have it stored on their personal calendar source with event notification capabilities.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions, or that which receives and executes instructions from a propagated signal so that a device connected to a network environment can send or receive voice, video or data, and to communicate over the network using the instructions. The instructions may further be transmitted or received over a network via the network interface device. While the machine-readable medium in an example embodiment may be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. § 1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method comprising:
searching video content according to criteria defined by a user; and
sending a notice to an electronic calendar with at least one entry that meets the criteria.

2. The method of claim 1 wherein the video content is stored on the Internet.

3. The method of claim 1 wherein the video content is stored on a local source.

4. The method of claim 1 wherein the notice includes information indicating a time for which the entry is scheduled.

5. The method of claim 1 wherein the notice includes information indicating a description of the entry.

6. The method of claim 1 wherein the notice is sent via email.

7. The method of claim 1 wherein the electronic calendar is associated with the user.

8. The method of claim 1 wherein the electronic calendar is associated with a person other than the user.

9. A graphical user interface for searching video content, the graphical user interface comprising:
a plurality of boxes that may be selected by a user to define a set of criteria; and
a box that may be selected by the user to send a notice to an electronic calendar with at least one entry that meets the criteria.

10. The graphical user interface of claim 9 wherein the video content is stored on the Internet.

11. The graphical user interface of claim 9 wherein the video content is stored on a local source.

12. The graphical user interface of claim 9 wherein the notice includes information indicating a time for which the entry is scheduled.

13. The graphical user interface of claim 9 wherein the notice includes information indicating a description of the entry.

14. The graphical user interface of claim 9 wherein the notice is sent via email.

15. The graphical user interface of claim 9 wherein the electronic calendar is associated with the user.

16. The graphical user interface of claim 9 wherein the electronic calendar is associated with a person other than the user.

17. A method for searching video content available on the Internet and on a local source, the method comprising:
accepting a plurality of criteria from a user; and
applying the criteria to search the video content at timed intervals defined by the user.

18. The method of claim 17 wherein the criteria include type.

19. The method of claim 17 wherein the criteria include rating information.

20. The method of claim 17 wherein the criteria are predefined.

21. The method of claim 17 wherein the criteria are customizable by the user.

22. A graphical user interface for facilitating a search of video content available on the Internet and on a local source, the graphical user interface comprising:
a plurality of boxes that may be selected by a user to define a set of criteria; and
a box that may be selected by the user to schedule the search at timed intervals defined by the user.

23. The graphical user interface of claim 22 wherein the criteria include type.

24. The graphical user interface of claim 22 wherein the criteria include rating information.

25. The graphical user interface of claim 22 wherein the criteria are customizable by the user.
